(19) United States
(12) Patent Application Publication
(10) Pub. No.: US 2006/0290600 A1
(43) Pub. Date: Dec. 28, 2006

(54) Plasma display apparatus and method of driving the same

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/472,416

(22) Filed: Jun. 22, 2006

(30) Foreign Application Priority Data
Jun. 24, 2005 (KR) 10-2005-0055336

(51) Int. Cl. G09G 3/28

(52) U.S. Cl. 345/60

(57) ABSTRACT

A plasma display apparatus and a method of driving the plasma display apparatus are disclosed. A waveform generator of the plasma display apparatus adjusts at least one of brightness and contrast through a reset pulse and a sustain pulse supplied to an electrode of a plasma display panel.

This Non-provisional application claims priority under 35 U.S.C. § 119(a) on Patent Application No. 10-2005-0055336 filed in Korea on Jun. 24, 2005 the entire contents of which are hereby incorporated by reference.

### BACKGROUND OF THE INVENTION

1. Field of the Invention

This document relates to a plasma display apparatus, and more particularly, to a method of driving a plasma display apparatus for improving the image quality by minimizing flicker.

2. Description of the Background Art

Generally, a plasma display apparatus comprises a plasma display panel in which a plurality of electrodes are formed and a driver for driving the electrodes of the plasma display panel.

Each of cells of the plasma display panel is filled with an inert gas containing a main discharge gas such as neon (Ne), helium (He) or a Ne—He gas mixture and a small amount of xenon (Xe). When a high frequency voltage is supplied to the electrodes of the plasma display panel, the inert gas within the cells generates vacuum ultraviolet rays. The vacuum ultraviolet rays emit a phosphor formed between barrier ribs such that the image is displayed.

The driver of the plasma display apparatus supplies a driving signal to the electrodes of the plasma display panel. The supply of the driving signal generates a reset discharge, an address discharge and a sustain discharge within the cells of the plasma display panel. When the discharge is generated within the cells, the inert gas within the cells generates vacuum ultraviolet rays. The vacuum ultraviolet rays emit the phosphor formed within the cells such that the image is displayed.

The plasma display apparatus represents gray scale by the combination of subfields. Each of the subfields comprises a reset period for initializing the whole screen, an address period for selecting cells to be discharged, and a sustain period for representing gray scale.

### SUMMARY OF THE INVENTION

According to an aspect, there is provided a plasma display apparatus comprising a plasma display panel comprising an electrode, a remote signal receiving unit for receiving a remote signal and for outputting an image control signal, a control unit for receiving the image control signal and for outputting a timing control signal for a change in a reset pulse, and a waveform generator for supplying the reset pulse to the electrode in response to the timing control signal.

According to another aspect, there is provided a plasma display apparatus comprising a plasma display panel comprising an electrode, a remote signal receiving unit for receiving a remote signal and for outputting a first image control signal and a second image control signal, a contrast control unit for receiving the first image control signal and for outputting a first timing control signal for a change in a reset pulse, a brightness control unit for receiving the second image control signal and for outputting a second timing control signal for a change in the duration of a sustain period, and a waveform generator for supplying the reset pulse and a sustain pulse in response to the first timing control signal and the second control signal.

According to still another aspect, there is provided a plasma display apparatus comprising a plasma display panel comprising an electrode, a remote signal receiving unit for receiving a remote signal and for outputting an image control signal, a control unit for receiving the image control signal and for outputting a timing control signal for a change in a sustain pulse, and a waveform generator for supplying the sustain pulse to the electrode in response to the timing control signal.

According to further another aspect, there is provided a method of driving a plasma display apparatus comprising an electrode, comprising receiving a remote signal to output a first timing control signal for changing a reset pulse, supplying the reset pulse in response to the first timing control signal, and supplying the reset pulse to the electrode.

### BRIEF DESCRIPTION OF THE DRAWINGS

The embodiment of the invention will be described in detail with reference to the following drawings in which like numerals refer to like elements.

FIG. 1 is a block diagram of a plasma display apparatus according to a first embodiment of the present invention;

FIG. 2 is a waveform diagram of a driving signal for driving the plasma display apparatus according to the first embodiment of the present invention;

FIG. 3 is a block diagram of a plasma display apparatus according to a second embodiment of the present invention;

FIG. 4 is a waveform diagram of a driving signal for driving the plasma display apparatus according to the second embodiment of the present invention; and

FIG. 5 is a block diagram of a plasma display apparatus according to a third embodiment of the present invention.

### DETAILED DESCRIPTION OF PREFERRED EMBODIMENTS

Embodiments of the present invention will be described in a more detailed manner with reference to the attached drawings.

A plasma display apparatus according to embodiments of the present invention comprises a plasma display panel comprising an electrode, a remote signal receiving unit for receiving a remote signal and for outputting an image control signal, a control unit for receiving the image control signal and for outputting a timing control signal for a change in a reset pulse, and a waveform generator for supplying the reset pulse to the electrode in response to the timing control signal.

The waveform generator may supply the reset pulse different from another reset pulse to the electrode during a reset period in one of two different subfields.

The waveform generator may supply the reset pulse different from another reset pulse to the electrode during a reset period of an n-th subfield in one of two different frames.

The waveform generator may supply the reset pulse comprising a setup pulse different from a setup pulse of another reset pulse to the electrode during a setup period in one of two different subfields.

At least one of a maximum voltage and the duration of a supply period of the setup pulse supplied during the setup period, may be different from at least one of a maximum voltage and the duration of a supply period of the setup pulse supplied during the remaining setup period.

The waveform generator may supply the reset pulse comprising a set-down pulse different from a set-down pulse of another reset pulse to the electrode during a set-down period in one of two different subfields.

At least one of a minimum voltage and the duration of a supply period of the set-down pulse supplied during the set-down period, may be different from at least one of a maximum voltage and the duration of a supply period of the set-down pulse supplied during the remaining set-down period.

The waveform generator may supply the reset pulse different from the number of another reset pulses to the electrode in one of two different frames.

A plasma display apparatus according to the embodiments of the present invention comprises a plasma display panel comprising an electrode, a remote signal receiving unit for receiving a remote signal and for outputting a first image control signal and a second image control signal, a contrast control unit for receiving the second image control signal and for outputting a second timing control signal for a change in a reset signal, a brightness control unit for receiving the second image control signal and for outputting a second timing control signal for a change in the duration of a sustain period, and a waveform generator for supplying the reset pulse and a sustain pulse in response to the first timing control signal and the second timing control signal.

The waveform generator may supply a different number of sustain pulses to the electrode during the sustain period of an n-th subfield in each of two different frames in response to the second timing control signal.

The waveform generator may supply the sustain pulse to the electrode during (x-y) subfields of x subfields in response to the second timing control signal, wherein x is the total number of subfields in a frame, and x is more than y.

The waveform generator may supply the reset pulse different from another reset pulse to the electrode during a reset period in one of two different subfields.

The waveform generator may supply the reset pulse different from another reset pulse to the electrode during a reset period of an n-th subfield in one of two different frames.

The waveform generator may supply the reset pulse comprising a setup pulse different from a setup pulse of another reset pulse to the electrode during a setup period in one of two different subfields.

The waveform generator may supply the reset pulse comprising a set-down pulse different from a set-down pulse of another reset pulse to the electrode during a set-down period in one of two different subfields.

The waveform generator may supply the reset pulse different from the number of another reset pulses to the electrode in one of two different frames.

A plasma display apparatus according to the embodiments of the present invention comprises a plasma display panel comprising an electrode, a remote signal receiving unit for receiving a remote signal and for outputting an image control signal, a control unit for receiving the image control signal and for outputting a timing control signal for a change in a sustain pulse, and a waveform generator for supplying the sustain pulse to the electrode in response to the timing control signal.

The waveform generator may supply a different number of sustain pulses to the electrode during the sustain period of an n-th subfield in each of two different frames in response to the timing control signal.

The waveform generator may supply the sustain pulse to the electrode during (x-y) subfields of x subfields in response to the timing control signal, wherein x is the total number of subfields in a frame, and x is more than y.

A method of driving a plasma display apparatus comprising an electrode according to the embodiments of the present invention comprises receiving a remote signal to output a first timing control signal for changing a reset pulse, supplying the reset pulse in response to the first timing control signal, and supplying the reset pulse to the electrode.

The driving method may further comprise receiving a remote signal to output a second timing control signal for changing the duration of a sustain period, and supplying a sustain pulse to the electrode in response to the second timing control signal.

A different number of sustain pulses may be supplied to the electrode during a sustain period of an n-th subfield in each of two different frames in response to the second timing control signal.

The sustain pulse may be supplied to the electrode during (x-y) subfields of x subfields in response to the second timing control signal, wherein x is the total number of subfields in a frame, and x is more than y.

The reset pulse different from another reset pulse may be supplied to the electrode during a reset period in one of two different subfields.

The reset pulse different from another reset pulse may be supplied to the electrode during a reset period of an n-th subfield in one of two different frames.

The reset pulse comprising a setup pulse different from a setup pulse of another reset pulse, may be supplied to the electrode during a setup period in one of two different subfields.

The reset pulse comprising a set-down pulse different from a set-down pulse of another reset pulse, may be supplied to the electrode during a set-down period in one of two different subfields.

The reset pulse different from the number of another reset pulses may be supplied to the electrode in one of two different frames.

Hereinafter, exemplary embodiments of the present invention will be described in detail with reference to the attached drawings.

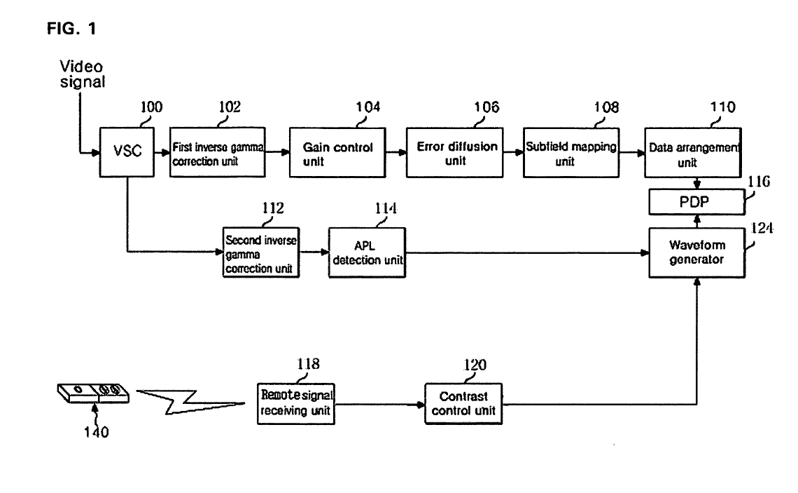

FIG. 1 is a block diagram of a plasma display apparatus according to a first embodiment of the present invention. As illustrated in FIG. 1, the plasma display apparatus according to the first embodiment of the present invention comprises a video signal control circuit unit 100, a first inverse gamma correction unit 102, a gain control unit 104, an error diffusion unit 106, a subfield mapping unit 108, a data arrangement unit 110, a second inverse gamma correction unit 112, an APL detection unit 114, a plasma display panel 116, a remote signal receiving unit 118, a contrast control unit 120, and a waveform generator 124.

The video signal control circuit unit 100 samples an analogue video signal in response to a clock signal, and converts the analogue video signal into a digital video signal.

The first inverse gamma correction unit 102 performs inverse-gamma correction on the digital video signal input from the video signal control circuit unit 100, and linearly converts a brightness value in accordance to a gray level value of an image signal.

The gain control unit 104 amplifies the corrected video data in the first inversion-gamma correction unit 102 by an effective gain.

The error diffusion unit 106 diffuses an error component of the video data input from the gain control unit 104 to adjacent discharge cells, thereby minutely adjusting a brightness value.

The subfield mapping unit 108 maps the video data input from the error diffusion unit 106 to the subfields, which are previously stored, and supplies the video data to the data arrangement unit 110.

The data arrangement unit 110 supplies the video data input from the subfield mapping unit 108 to a data driving IC (not shown). The data driving IC is connected to an address electrode of the plasma display panel 116, and latches the video data input from the data arrangement unit 110 by 1vertical line. Then, the data driving IC supplies the latched video data to the address electrode by 1 vertical period unit

The second inverse gamma correction unit 112 performs inverse-gamma correction on the digital video signal input from the video signal control circuit unit 100, and linearly converts a brightness value in accordance to a gray level value of an image signal.

The APL detection unit 114 detects average brightness, that is, an APL (average picture level) from the data input from the second inverse gamma correction unit 112 by a frame unit.

The remote signal receiving unit 118 receives a remote signal sent from a remote controller 140 or a push-button switch (not shown), and supplies an image control signal to the contrast control unit 120.

The contrast control unit 120 receives the image control signal, and outputs a timing control signal for changing a reset pulse supplied to a scan electrode of the plasma display panel 116.

The waveform generator 124 supplies the reset pulse to the scan electrode of the plasma display panel 116 in response to the timing control signal output from the contrast control unit 120.

The plasma display apparatus according to the first embodiment of the present invention does not change the video signal input to the video signal control circuit unit 100 for the purpose of the adjustment of contrast, but adjusts the reset pulse input to the scan electrode of the plasma display panel 116.

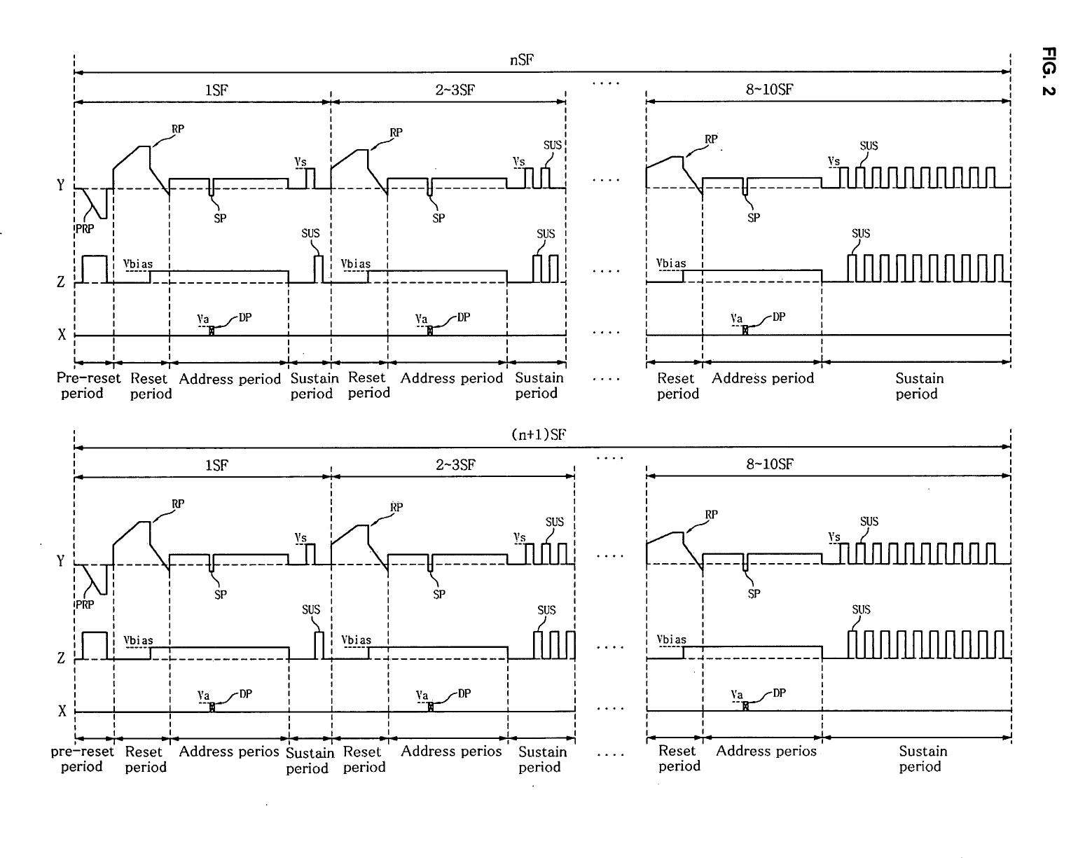

FIG. 2 is a waveform diagram of a driving signal for driving the plasma display apparatus according to the first embodiment of the present invention. As illustrated in FIG. 2, the waveform generator 124 supplies a pre-reset signal PRP with a gradually falling voltage to the scan electrode Y in a pre-reset period of a first subfield 1SF to sufficiently accumulate wall charges. Further, the waveform generator 124 supplies a reset signal RP for initializing a state of the wall charges within the discharge cells, a scan signal SP for selecting discharge cells, and a sustain signal SUS for generating a sustain discharge within the selected discharge cells to the scan electrode Y.

The waveform generator 124 supplies a positive voltage corresponding to the pre-reset signal PRP to a sustain electrode Z. Further, the waveform generator 124 supplies a bias voltage Vbias and a sustain signal SUS for generating a sustain discharge within the selected discharge cells to the sustain electrode Z.

The data driving IC supplies a data signal DP corresponding to the scan signal SP to the address electrode X to select the discharge cells.

The waveform generator 124 receives the timing control signal output from the contrast control unit 120. The waveform generator 124 supplies the reset pulse RP different from another reset pulse RP to the scan electrode Y during a reset period of one of two different subfields. For example, the waveform generator 124 supplies the reset pulse RP including a setup pulse different from a setup pulse of another reset pulse RP to the scan electrode Y during a setup period of one of two different subfields. As illustrated in FIG. 2, the reset pulses RP supplied in the reset periods of the first subfield 1SF, a second subfield 2SF, a fourth subfield 4SF and an eighth subfield 8SF are different from one another. Further, the durations of supply periods or slopes of the setup pulses supplied in the first, second, fourth and eighth subfields 1SF, 2SF, 4SF and 8SF may be different from one another. Further, maximum voltages of the setup pulses supplied in the subfields 1SF, 2SF, 4SF and 8SF may be different from one another.

Further, the waveform generator 124 supplies the reset pulse RP including a set-down pulse different from a set-down pulse of another reset pulse RP to the scan electrode Y during a set-down period of one of two different subfields. As illustrated in FIG. 2, the durations of supply periods or slopes of the set-down pulses supplied in the first, second, fourth and eighth subfields 1SF, 2SF, 4SF and 8SF may be different from one another. Further, minimum voltages of the set-down pulses supplied in the subfields 1SF, 2SF, 4SF and 8SF may be different from one another.

The waveform generator 124 supplies the reset pulse RP different from another reset pulse RP to the scan electrode Y during a reset period of an n-th subfield in one of two different frames. For example, the reset pulse SP supplied in the second subfield of a first frame is different from the reset pulse SP supplied in the second subfield of a second frame.

The waveform generator 124 supplies the reset pulse different from the number of another reset pulses to the scan electrode Y in one of two different frames. For example, when a frame comprises 10 subfields, the number of reset pulses supplied to the scan electrode Y in one frame may be 10 and the number of reset pulses supplied to the scan electrode Y in another frame may be 8. When wall charges are sufficiently accumulated on the electrode in the reset period of the first subfield, no reset pulse may be supplied in another subfield.

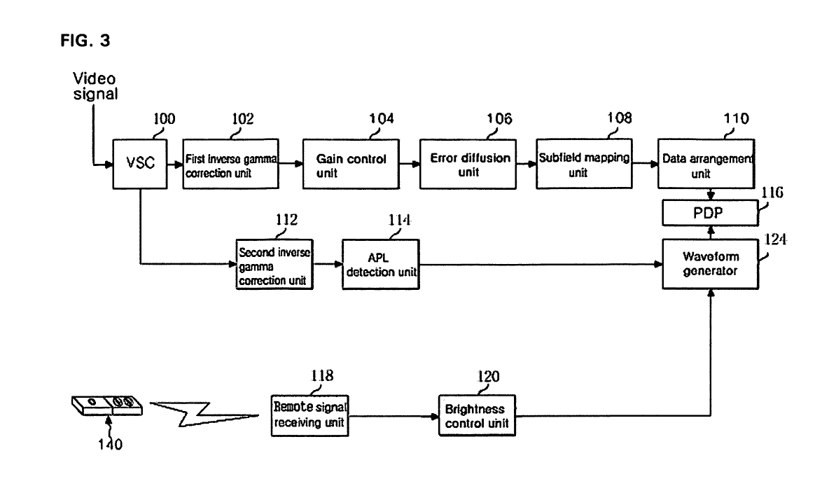

FIG. 3 is a block diagram of a plasma display apparatus according to a second embodiment of the present invention. As illustrated in FIG. 3, the plasma display apparatus according to the second embodiment of the present invention comprises a video signal control circuit unit 100, a first inverse gamma correction unit 102, a gain control unit 104, an error diffusion unit 106, a subfield mapping unit 108, a data arrangement unit 110, a second inverse gamma correction unit 112, an APL detection unit 114, a plasma display panel 116, a remote signal receiving unit 118, a brightness control unit 122, and a waveform generator 124.

Since the video signal control circuit unit 100, the first inverse gamma correction unit 102, the gain control unit 104, the error diffusion unit 106, the subfield mapping unit 108, the data arrangement unit 110, the second inverse gamma correction unit 112, and the APL detection unit 114 in the plasma display apparatus according to the second embodiment of the present invention were described in the first embodiment of the present invention, a detailed description thereof is omitted.

The remote signal receiving unit 118 receives a remote signal sent from a remote controller 140 or a push-button switch (not shown), and supplies an image control signal to the brightness control unit 122.

The brightness control unit 122 receives the image control signal, and outputs a timing control signal for changing the duration of a sustain period when a sustain pulse is supplied to a scan electrode and a sustain electrode of the plasma display panel 116.

The waveform generator 124 supplies the sustain pulse to the scan electrode and the sustain electrode of the plasma display panel 116 in response to the timing control signal output from the brightness control unit 122.

The plasma display apparatus according to the second embodiment of the present invention does not change the video signal input to a video signal control circuit unit 100 for the purpose of the adjustment of brightness, but adjusts the duration of the sustain period when the sustain pulse is supplied to the scan electrode and the sustain electrode of the plasma display panel 116.

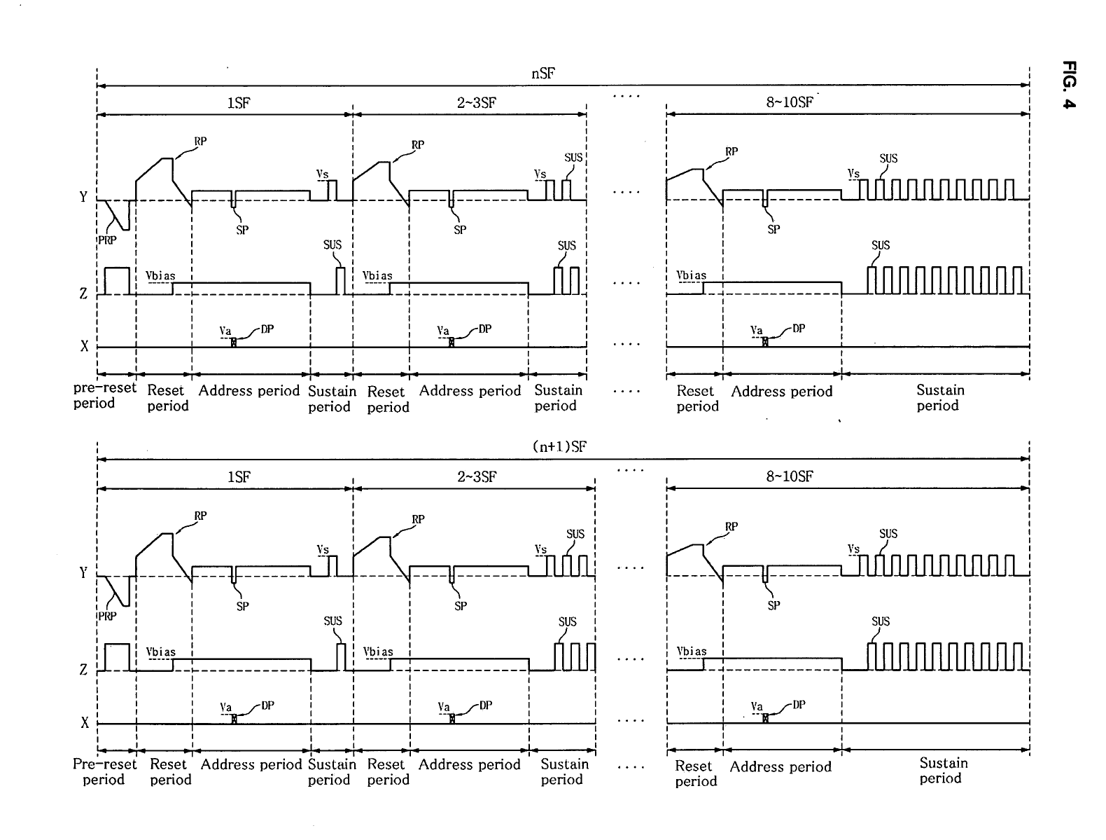

FIG. 4 is a waveform diagram of a driving signal for driving the plasma display apparatus according to the second embodiment of the present invention. As illustrated in FIG. 4, the waveform generator 124 receives the timing control signal. The waveform generator 124 supplies a different number of sustain pulses to the scan electrode Y and the sustain electrode Z during the sustain period of an n-th subfield in each of two different frames in response to the timing control signal. For example, as illustrated in FIG. 4, the number of sustain pulses supplied in a second subfield 2SF of an n-th frame is less than the number of sustain pulses supplied in a second subfield 2SF of an n+1-th frame. Accordingly, the duration of the sustain period in the second subfield 2SF of the n+1-th frame is more than the duration of the sustain period in the second subfield 2SF of the n-th frame. The brightness in the n+1-th frame is more than the brightness in the n-th frame.

The waveform generator 124 supplies the sustain pulse to the scan electrode Y and the sustain electrode Z during (x-y) subfields of x subfields in response to the timing control signal. Wherein x is the total number of subfields in a frame, and x is more than y. For example, when a frame comprises 10 subfields, no sustain pulse may be supplied in a special subfield. Accordingly, a sum of the durations of the sustain periods of all of the subfields included in one frame may change, and the brightness may also change.

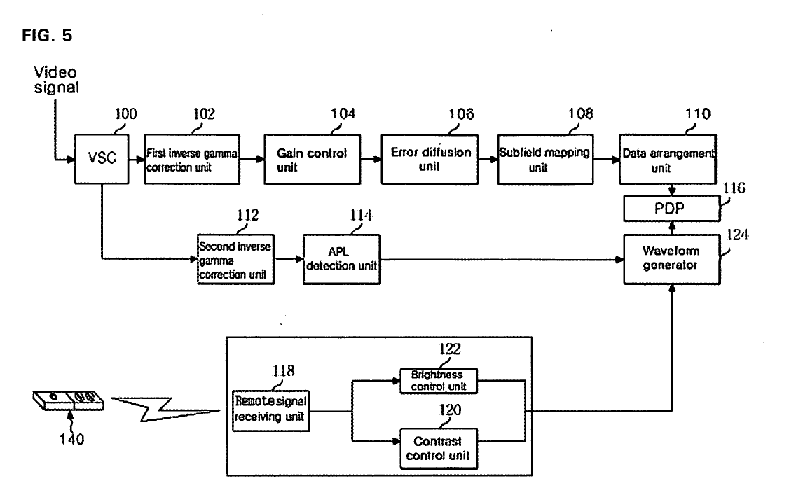

FIG. 5 is a block diagram of a plasma display apparatus according to a third embodiment of the present invention. As illustrated in FIG. 5, the plasma display apparatus according to the third embodiment of the present invention comprises a video signal control circuit unit 100, a first inverse gamma correction unit 102, a gain control unit 104, an error diffusion unit 106, a subfield mapping unit 108, a data arrangement unit 110, a second inverse gamma correction unit 112, an APL detection unit 114, a plasma display panel 116, a remote signal receiving unit 118, a contrast control unit 120, a brightness control unit 122, and a waveform generator 124.

The third embodiment of the present invention changes at least one of contrast and brightness of the plasma display apparatus in response to the remote signal. Since the video signal control circuit unit 100, the first inverse gamma correction unit 102, the gain control unit 104, the error diffusion unit 106, the subfield mapping unit 108, the data arrangement unit 110, the second inverse gamma correction unit 112, and the APL detection unit 114 in the plasma display apparatus according to the third embodiment of the present invention were described in the first embodiment of the present invention, a detailed description thereof is omitted.

The remote signal receiving unit 118 receives a remote signal sent from a remote controller 140 or a push-button switch (not shown), and outputs a first image control signal and a second image control signal.

The contrast control unit 120 receives the first image control signal from the remote signal receiving unit 118, and outputs a first timing control signal.

The brightness control unit 122 receives the second image control signal from the remote signal receiving unit 118, and outputs a second timing control signal.

The waveform generator 124 supplies a reset pulse to a scan electrode and supplies a sustain pulse to the scan electrode and a sustain electrode in response to the first and second timing control signals.

The plasma display apparatus according to the third embodiment of the present invention does not change a video signal input to the video signal control circuit unit 100 for the purpose of the adjustment of the contrast and the brightness, but adjusts the reset pulse supplied to the scan electrode of the plasma display panel 116 and adjust the duration of the sustain period when the sustain pulse is supplied to the scan electrode and the sustain electrode of the plasma display panel 116.

The waveform generator 124 supplies the reset pulse different from another reset pulse to the scan electrode during a reset period of one of two different subfields in response to the first timing control signal. Since this was described in the first embodiment of the present invention, a description thereof is omitted.

The waveform generator 124 supplies a different number of sustain pulses to the scan electrode and the sustain electrode during a sustain period of an n-th subfield in each of two different frames in response to the second timing control signal. Further, the waveform generator 124 supplies the sustain pulse to the scan electrode Y and the sustain electrode Z during (x-y) subfields of x subfields in response to the second timing control signal. Wherein x is the total number of subfields in a frame, and x is more than y. Since this was described in the second embodiment of the present invention, a description thereof is omitted.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising an electrode;
a remote signal receiving unit for receiving a remote signal and for outputting an image control signal;
a control unit for receiving the image control signal and for outputting a timing control signal for a change in a reset pulse; and
a waveform generator for supplying the reset pulse to the electrode in response to the timing control signal.

2. The plasma display apparatus of claim 1, wherein the waveform generator supplies the reset pulse different from another reset pulse to the electrode during a reset period in one of two different subfields.

3. The plasma display apparatus of claim 1, wherein the waveform generator supplies the reset pulse different from another reset pulse to the electrode during a reset period of an n-th subfield in one of two different frames.

4. The plasma display apparatus of claim 1, wherein the waveform generator supplies the reset pulse comprising a setup pulse different from a setup pulse of another reset pulse to the electrode during a setup period in one of two different subfields.

5. The plasma display apparatus of claim 4, wherein at least one of a maximum voltage and the duration of a supply period of the setup pulse supplied during the setup period, is different from at least one of a maximum voltage and the duration of a supply period of the setup pulse supplied during the remaining setup period.

6. The plasma display apparatus of claim 1, wherein the waveform generator supplies the reset pulse comprising a set-down pulse different from a set-down pulse of another reset pulse to the electrode during a set-down period in one of two different subfields.

7. The plasma display apparatus of claim 6, wherein at least one of a minimum voltage and the duration of a supply period of the set-down pulse supplied during the set-down period, is different from at least one of a maximum voltage and the duration of a supply period of the set-down pulse supplied during the remaining set-down period.

8. The plasma display apparatus of claim 1, wherein the waveform generator supplies the reset pulse different from the number of another reset pulses to the electrode in one of two different frames.

9. A plasma display apparatus comprising:
a plasma display panel comprising an electrode;
a remote signal receiving unit for receiving a remote signal and for outputting a first image control signal and a second image control signal;
a contrast control unit for receiving the first image control signal and for outputting a first timing control signal for a change in a reset pulse;
a brightness control unit for receiving the second image control signal and for outputting a second timing control signal for a change in the duration of a sustain period; and
a waveform generator for supplying the reset pulse and a sustain pulse in response to the first timing control signal and the second timing control signal.

10. The plasma display apparatus of claim 9, wherein the waveform generator supplies a different number of sustain pulses to the electrode during the sustain period of an n-th subfield in each of two different frames in response to the second timing control signal.

11. The plasma display apparatus of claim 9, wherein the waveform generator supplies the sustain pulse to the electrode during (x-y) subfields of x subfields in response to the second timing control signal, and
wherein x is the total number of subfields in a frame, and x is more than y.

12. The plasma display apparatus of claim 9, wherein the waveform generator supplies the reset pulse different from another reset pulse to the electrode during a reset period in one of two different subfields.

13. The plasma display apparatus of claim 9, wherein the waveform generator supplies the reset pulse different from another reset pulse to the electrode during a reset period of an n-th subfield in one of two different frames.

14. The plasma display apparatus of claim 9, wherein the waveform generator supplies the reset pulse comprising a setup pulse different from a setup pulse of another reset pulse to the electrode during a setup period in one of two different subfields.

15. The plasma display apparatus of claim 9, wherein the waveform generator supplies the reset pulse comprising a set-down pulse different from a set-down pulse of another reset pulse to the electrode during a set-down period in one of two different subfields.

16. The plasma display apparatus of claim 9, wherein the waveform generator supplies the reset pulse different from the number of another reset pulses to the electrode in one of two different frames.

17. A plasma display apparatus comprising:
a plasma display panel comprising an electrode;
a remote signal receiving unit for receiving a remote signal and for outputting an image control signal;
a control unit for receiving the image control signal and for outputting a timing control signal for a change in a sustain pulse; and
a waveform generator for supplying the sustain pulse to the electrode in response to the timing control signal.

18. The plasma display apparatus of claim 17, wherein the waveform generator supplies a different number of sustain pulses to the electrode during the sustain period of an n-th subfield in each of two different frames in response to the timing control signal.

19. The plasma display apparatus of claim 17, wherein the waveform generator supplies the sustain pulse to the electrode during (x-y) subfields of x subfields in response to the timing control signal, and
wherein x is the total number of subfields in a frame, and x is more than y.

20. A method of driving a plasma display apparatus comprising an electrode, comprising:
receiving a remote signal to output a first timing control signal for changing a reset pulse;
supplying the reset pulse in response to the first timing control signal; and
supplying the reset pulse to the electrode.

21. The method of claim 20, further comprising receiving a remote signal to output a second timing control signal for changing the duration of a sustain period, and
supplying a sustain pulse to the electrode in response to the second timing control signal.

22. The method of claim 21, wherein a different number of sustain pulses are supplied to the electrode during a sustain period of an n-th subfield in each of two different frames in response to the second timing control signal.

23. The method of claim 21, wherein the sustain pulse is supplied to the electrode during (x-y) subfields of x subfields in response to the second timing control signal, and
wherein x is the total number of subfields in a frame, and x is more than y.

24. The method of claim 21, wherein the reset pulse different from another reset pulse is supplied to the electrode during a reset period in one of two different subfields.

25. The method of claim 21, wherein the reset pulse different from another reset pulse is supplied to the electrode during a reset period of an n-th subfield in one of two different frames.

26. The method of claim 21, wherein the reset pulse comprising a setup pulse different from a setup pulse of another reset pulse, is supplied to the electrode during a setup period in one of two different subfields.

27. The method of claim 21, wherein the reset pulse comprising a set-down pulse different from a set-down pulse of another reset pulse, is supplied to the electrode during a set-down period in one of two different subfields.

28. The method of claim 21, wherein the reset pulse different from the number of another reset pulses is supplied to the electrode in one of two different frames.
